(19) United States
(12) Patent Application Publication
(10) Pub. No.: US 2008/0047141 A1
(43) Pub. Date: Feb. 28, 2008

(54) Method for fabricating supporting column of heat sink

(75) Inventor: Hsiu-Fei Yang, Taipei City (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/501,643

(22) Filed: Aug. 8, 2006

(51) Int. Cl. B21D 53/02; B23P 15/26

(52) U.S. Cl. 29/890.03; 29/890.053

(57) ABSTRACT

A method for fabricating a supporting column of a heat sink is disclosed. A substrate having a concave portion, and a material injection board having a through hole are prepared first. The material injection board is then mounted on the concave portion of the substrate with the through hole of the material injection board being located at a position of the substrate where a supporting column is to be formed. Aggregate is injected into the through hole, and then the substrate, the material injection board and the aggregate are disposed under a high-temperature environment for sintering. After the aggregate is formalized, the material injection board is removed from the substrate so as to obtain a substrate having a supporting column formed on the concave portion. Since the supporting column fabricated according to the above method has improved capillary structure and density, the heat sink has an improved heat dissipating efficiency.

### BACKGROUND OF THE INVENTION

1. Field of the Invention

The present invention relates generally to a method for fabricating a heat sink, and more particularly to a method for fabricating a supporting column of a heat sink.

2. Description of Related Art

With the rapid development of integrated circuit design and fabrication technology, the level of integration of integrated circuits increases. Accordingly, how to efficiently dissipate heat generated by the integrated circuits such as a central processing unit during operation has become much more critical. Generally, heat sinks are disposed on the integrated circuits for heat dissipation. Heat sinks are made of materials that can absorb and dissipate heat efficiently. To further improve heat dissipating efficiency, heat sinks can be used in combination with fins, fans or liquid cooled structures. The heat sinks, if used in combination with liquid cooled structures, can obtain better heat dissipating efficiency.

FIG. 2A is an exploded diagram of a conventional liquid cooled heat sink 2. The heat sink 2 comprises a lower substrate 21 and an upper substrate 22 opposed to the lower substrate 21. The lower substrate 21 has a concave portion 211 and a plurality of supporting columns 23 formed on the concave portion 211 of the lower substrate 21 for supporting the upper substrate 22. A through hole 221 is formed at a corner of the upper substrate 22. Referring to FIG. 2B, after the lower substrate 21 and the upper substrate 22 are tightly fixed together through fixing components (not shown) or by a soldering mechanism, the supporting columns 23 can effectively support the upper substrate 22. Therefore, a cooled liquid 25, after injected through the through hole 221 into a receiving space 24 formed between the upper substrate 22 and the lower substrate 21 and the through hole 221 is sealed, dissipate heat by transforming itself from a vapor state into a liquid state and vice versa according to different working temperatures.

The fabrication method for fabricating the supporting columns 23 is shown in FIG. 3. Aggregate is continuously deposited on the concave portion 211 of the lower substrate 21 at positions where the supporting columns 23 are to be formed until the aggregate has a height equal to a certain level such that cone-shaped supporting columns 23 can be obtained. However, in the above fabrication process, the density of a capillary structure of the supporting columns 23 is difficult to be controlled and the capillary structure is easy to be broken, thereby resulting in a low density capillary structure of the supporting columns 23. The low density of the capillary structure further leads to small capillary forces to absorb the cooled liquid 25 injected into the receiving space 24. Thereby, the circulation efficiency of the cooled liquid 25 in the receiving space 24 is adversely affected, that is, the heat circulation efficiency is adversely affected.

Accordingly, there exists a strong need in the art for a heat sink and fabrication method which can control and improve capillary structure and density of the supporting columns so as to increase heat dissipating efficiency of the heat sink.

### SUMMARY OF THE INVENTION

Accordingly, an objective of the present invention is to provide a method for fabricating a supporting column of a heat sink that can control density and capillary structure of the supporting column of the heat sink.

To achieve the above and other objectives, the method for fabricating a supporting column of a heat sink according to the present invention comprises: preparing a substrate with a concave portion; disposing a material injection board having at least a through hole on the concave portion of the substrate, wherein the through hole of the material injection board is located at a position of the substrate where a supporting column is to be formed; injecting aggregate into the through hole of the material injection board; disposing the substrate, the material injection board and the aggregate under a high temperature environment for sintering; and removing the material injection board from the substrate after the aggregate is formalized so as to form a supporting column on the concave portion of the substrate.

Compared with the prior art, the method for fabricating a supporting column of a heat sink of the present invention can control and improve density and capillary structure of the supporting column. As a result, heat dissipating efficiency of the heat sink is increased.

### BRIEF DESCRIPTION OF DRAWINGS

FIGS. 1A to 1E illustrate a fabrication method for fabricating a supporting column of a heat sink according to the present invention;

FIG. 2A is a diagram of an exploded diagram of a conventional liquid cooled heat sink;

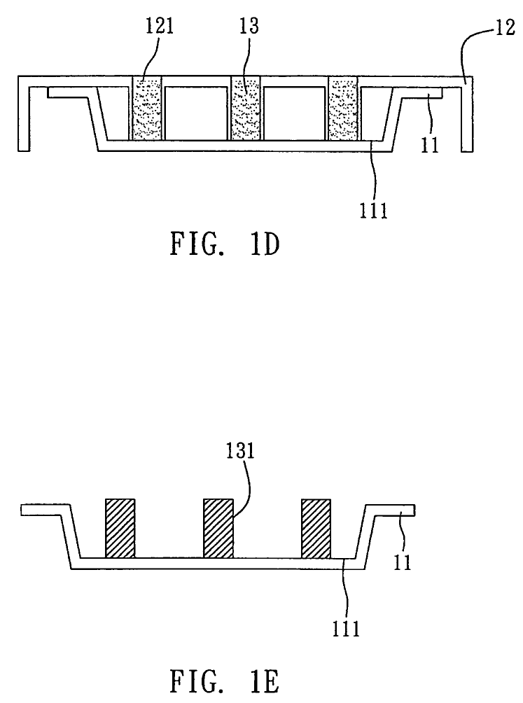

FIG. 2B is a diagram of the conventional liquid cooled heat sink after assembly; and

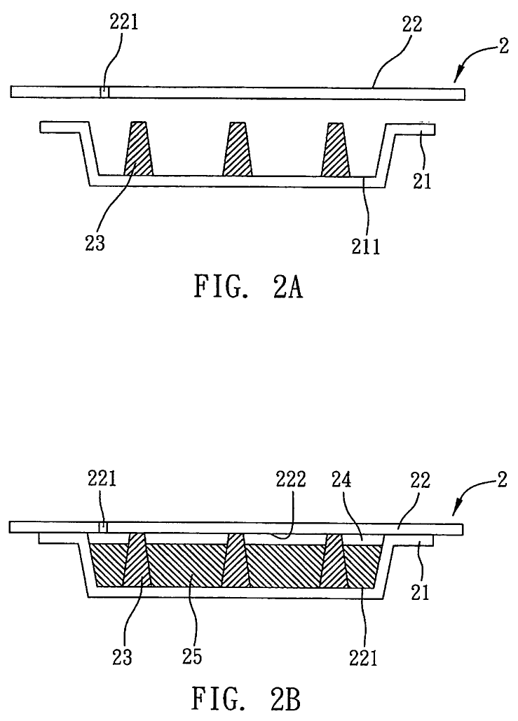

FIG. 3 shows a fabrication method of a supporting column of the conventional liquid cooled heat sink.

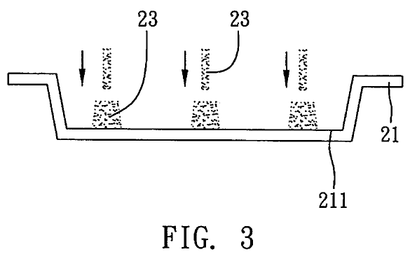

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be devised without departing from the spirit of the present invention.

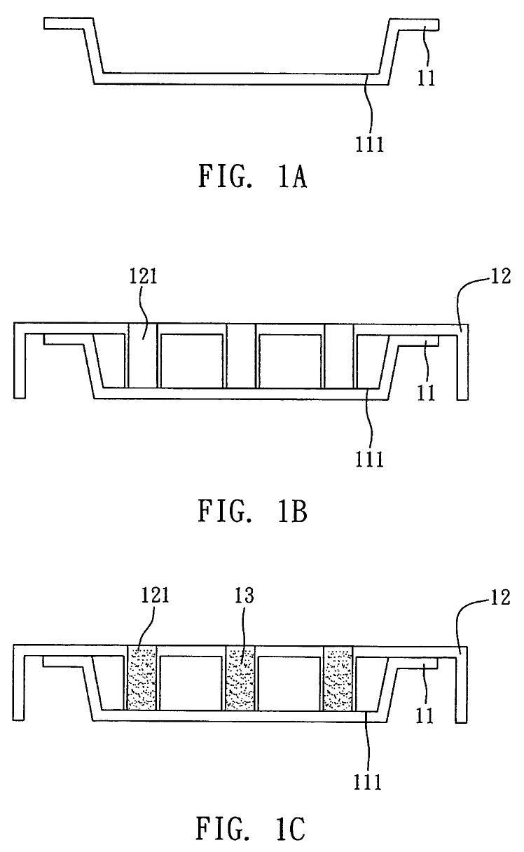

FIGS. 1A to 1E show a method for fabricating a supporting column of a heat sink according to the present invention.

First, as shown in FIG. 1A, a substrate 11 is provided. The substrate 11 is made of copper, aluminum or alloy thereof. In the present invention, a concave portion 111 is formed in a central portion of the substrate 11, and has a size defined according to volume of the cooled liquid to be injected to the substrate 11.

Then, as shown in FIG. 1B, a material injection board 12 having at least a through hole 121 is disposed on the concave portion 111 of the substrate 11. The through hole 121 of the material injection board 12 is located at a position of the substrate 11 where a supporting column is to be formed. In the present embodiment, the through hole 121 of the material injection board 12 has a cylindrical structure. Of course, the through hole 121 may have other structures. Preferably, if the material injection board 12 has two through holes 121, these through holes 121 are equal to each other in diameter.

As shown in FIG. 1C, aggregate 13 is injected into the through hole 121. The aggregate 13 is made of copper, aluminium or alloy thereof. In the present embodiment, the aggregate 13 is predisposed above the material injection board 12 and injected into the through hole 121 while being shaken.

Further, as shown in FIG. 1D, the substrate 11, the material injection board 12 and the aggregate 13 are disposed under a high temperature environment for sintering. In the present embodiment, the high temperature environment is provided by such as a high temperature furnace.

Finally, as shown in FIG. 1E, after the aggregate 13 is formalized, the material injection board 12 is removed from the substrate 11. Thereby, a supporting column 131 is formed on the concave portion 111 of the substrate 11. In the present embodiment, after the aggregate 13 is sintered, the substrate 11, the material injection board 12 and the aggregate 13 are removed from the high temperature environment, and the material injection board 12 is removed from the substrate 11 so as to form the supporting column 131.

Through the above method, capillary structure and density of the supporting column can be controlled and improved, thereby increasing heat dissipating efficiency of the heat sink.

The above-described descriptions of the detailed embodiments are only to illustrate the preferred implementation according to the present invention, and it is not to limit the scope of the present invention, i.e., other changes still can be implemented in the present invention. Accordingly, all modifications and variations completed by those with ordinary skill in the art should fall within the scope of present invention defined by the appended claims.

What is claimed is:

1. A method for fabricating a supporting column of a heat sink, comprising:
providing a substrate having a concave portion;
disposing a material injection board having at least a through hole on the concave portion of the substrate, wherein the through hole of the material injection board is located at a position of the substrate where a supporting column is to be formed;
injecting aggregate into the through hole of the material injection board;
disposing the substrate, the material injection board and the aggregate under a high temperature environment for sintering; and
removing the material injection board from the substrate after the aggregate is formalized so as to form the supporting column on the concave portion of the substrate.

2. The fabrication method of claim 1, wherein the concave portion is located at a central portion of the substrate.

3. The fabrication method of claim 1, wherein the substrate is made of materials selected from the group consisting of copper, aluminum and alloy thereof.

4. The fabrication method of claim 1, wherein the through hole has a cylindrical structure.

5. The fabrication method of claim 1, wherein the material injection board has two through holes equal to each other in diameter.

6. The fabrication method of claim 1, wherein the aggregate is made of material selected from the group consisting of copper, aluminum and alloy thereof.

7. The fabrication method of claim 1, wherein the high temperature environment is provided by a high temperature furnace.

8. The fabrication method of claim 1, wherein the aggregate is pre-disposed above the material injection board, and injected into the through hole of the material injection board while being shaken.
